(19) United States
(12) Patent Application Publication
(10) Pub. No.: US 2014/0153764 A1
(43) Pub. Date: Jun. 5, 2014

(54) Decorative Tubing for Earphone/Headphone Cords Personalization

(71) Applicant: Garrett Joseph Brigman, Milwaukee, WI (US)

(72) Inventor: Garrett Joseph Brigman, Milwaukee, WI (US)

(21) Appl. No.: 13/706,319

(22) Filed: Dec. 5, 2012

(51) Int. Cl. H04R 1/10

(52) U.S. Cl. CPC H04R 1/1033
USPC 381/370

(57) ABSTRACT

This device is directed towards ornamentation and other products used to personalize audio earphone/headphone cords. This invention can allow users to personalize an existing pair of earphone/headphone cords with decorative/colored tubing of various shapes and lengths. This invention will allow earphone/headphones users the ability to express themselves to those around them in a fashion previously unavailable.

### CROSS REFERENCE TO RELATED APPLICATIONS

“Not Applicable”

### STATEMENT REGARDING FEDERALLY SPONSORED RESEARCHOR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### FIELD OF THE INVENTION

This invention generally relates to the field of earphone/headphone cord personalization, and ornamentation.

### BACKGROUND OF THE INVENTION

Today earphones/headphones are used every day with cell phones, smart phones, mp3 players, tablets, and personal computers. The earphones/headphones provided with these devices, or for purchase as an aftermarket item are generally colored either white or black with some colored exceptions available in the earphones/headphones aftermarket.

There currently exists no solution for a user to easily custom color or pattern their existing earphones/headphones cords. This invention seeks to give users a new way to express themselves by providing the user a product enabling them to custom color and pattern their existing earphones/headphones cords.

### BACKGROUND ART

The Zeig patent application 2008/0285785 teaches that earphone/headphone ornamentation may be clipped on existing earphones/headphones. It also teaches that the ornamentation is a representation of any simple object. However this device leaves open the possibility of colored/decorative tubing that can be used to create custom coloring and patterning of existing earphone/headphone cords.

The Staley patent application 2012/0170787 teaches that ornamentation can be a part of the earphones/headphones manufacturing process. Like the Zeig patent the Staley patent also teaches the use of simple object designs for earphones/headphones ornamentation. This also leaves open the possibility of colored/decorative tubing that can be used to create custom coloring and patterning of existing earphone/headphone cords.

### BRIEF SUMMARY

This invention pertains to systems and means of providing an ornamental design for allowing users a way to custom color and pattern their earphones/headphones cords. This invention allows a user a way to express their personality, fashion, favorite sports teams, and individuality to those around them through the use of colored tubing that can be attached and customized to the user's preference.

### BRIEF DESCRIPTION OF THE SEVERAL VIEWS OF THE DRAWING

FIG. 1 is an illustration of the invention as applied to a user's earphones/headphones.

FIG. 2 is an explanatory drawing of the invention as applied to the audio earphones/headphones cord.
The audio headphone is shown in broken lines for illustrative purposes only and forms no part of the claimed design.

FIG. 3 is a top view of the invention, the bottom side being a mirror image.

FIG. 4 is a front view of the colored tube.

FIG. 5 is a rear view of the colored tube.

FIG. 6 is a detailed cross sectional view of the invention taken along a line 4-4 shown in FIG. 4.

FIG. 7 is an isometric view of the colored tube illustrating a three dimensional view of the invention when not applied to the earphone/headphone audio cords.

### DETAILED DESCRIPTION OF THE INVENTION

As described above earphones/headphones cords generally come in black or white with some exceptions. The invention shown in the drawings below will allow a user to color their existing earphones/headphones in one color, many colors, or a pattern of colors.

To date there are currently two solutions that allow a user express themselves through earphones/headphones ornamentation. Both existing solutions require a user to express themselves through the use of a simple molded object or design. One solution being a removable object/design, and the other including the object/design manufactured as part of the earphones/headphones. Neither of the previous solutions allow a user to add and remove sections of colored/decorative tubing to create a completely unique earphones/headphones cord.

The presently described invention will enable users to individualize and express themselves in a unique way that has previously not been available. The described invention will now be described in detail with reference to the attached drawings. The embodiments of the invention presented in the attached drawings may be in many different forms and may not be construed as limited to the embodiments set forth herein. These embodiments are provided so that this disclosure will satisfy applicable legal requirements set forth herein. Like numbers refer to like elements throughout.

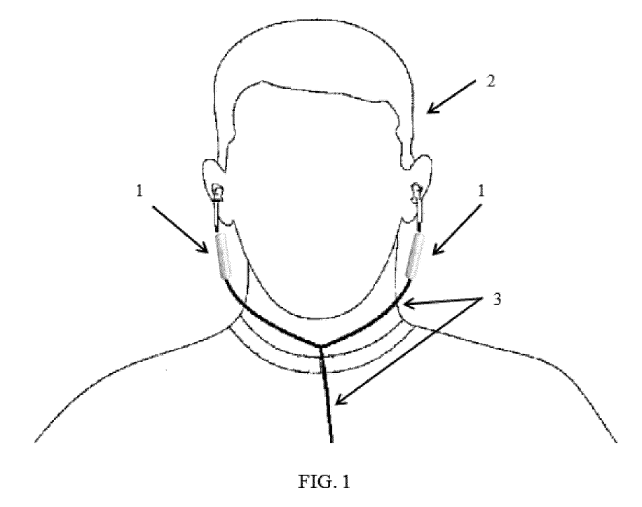

FIG. 1, overall invention 1 shows a user 2 with the invention 1 described applied to a pair of earphones/headphones cords 3.

FIG. 2, illustrates a detailed view the colored/decorative tubing 1 applied to a pair of earphones/headphones 3. The tubing 1 is not drawn to scale and may embody the entire length of the earphones/headphones 3. Conversely the decorative tubing 1 may also be a shorter length allowing the user to create patterns and themes of their choice along either a section or the full length of the earphones/headphones 3.

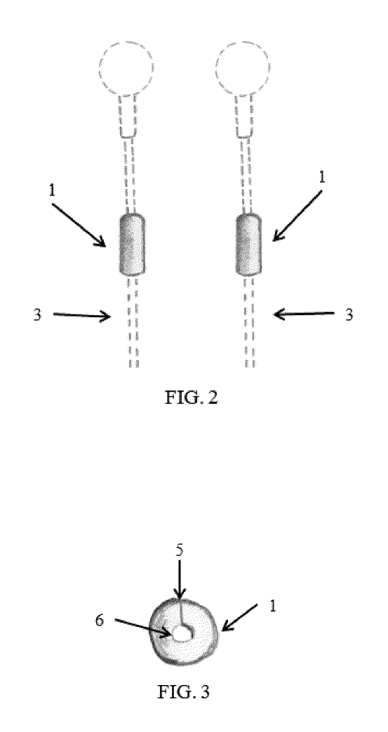

FIG. 3, illustrates a top view of the invention 1. The bottom view is not being shown because it is a mirror image of FIG. 3. The invention is a hollow tube allowing a space 6 for attachment to the earphones/headphones 3. FIG. 3 also depicts a slit 5 in the colored/decorative tubing enabling the addition and removal of the invention 1 from the earphones/headphones 3 by the user 2. The slit 5 shall enable the invention the flexibility to be pressed onto the earphones/headphones cord 3 by hand and wrap around the earphones/headphones cord changing the appearance of that section thereof.

The material composition of the colored/decorative tubing 1 may be of polymeric construction, but not limited to polymeric materials so long as the colored/decorative tubing is still able to be applied and removed by a user 2 to a pair of earphones/headphones 3 as previously described in section [0022].

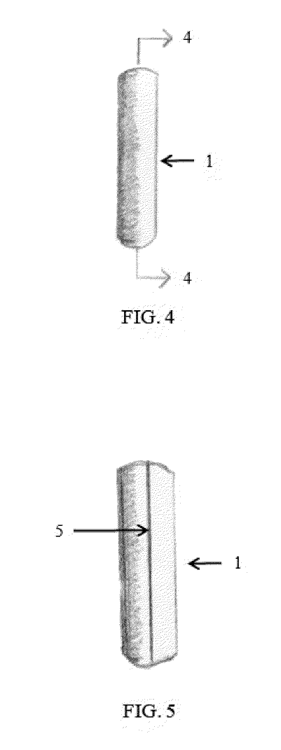

FIG. 4, is an illustration showing a front view of the colored/decorative tube 1. As previously stated the drawing is not to scale and may be any length allowing a user full or partial coverage of the earphones/headphones cord 3.

FIG. 5, is an illustration showing the rear view of the decorative/colored tubing 1. The rear view shows the slit 5 previously described in section [0022]. The slit 5 runs the entire length of the colored/decorative tube 1 allowing the addition and removal by the user 2 to the earphones/headphones cord 3.

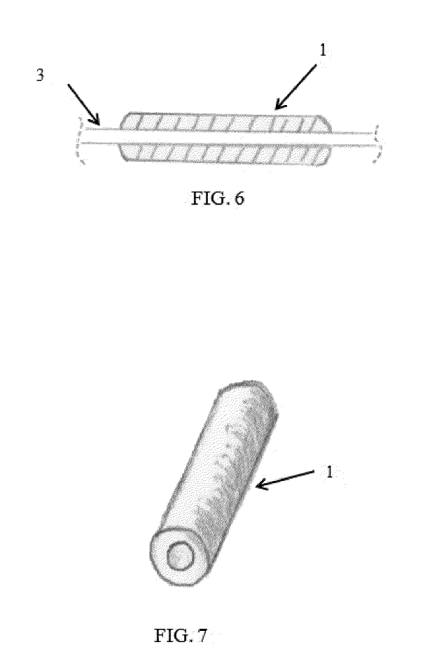

FIG. 6, is a cross sectional drawing of the invention 1 as applied to the earphones/headphones cord 3. The invention is added and removed by the user 2 by pressing the earphones/headphones cord 3 into the slit 5 allowing the colored/decorative tubing to wrap around the earphones/headphones cord 3.

FIG. 7, is a three dimensional representation of the invention 1. Throughout the specification circular tubing extrusions 1 have been used as an example, but is not limited to being only a circular extrusion. The colored/decorative tubing 1 may be extruded as a representation of any shape.

That which is claimed:

1. The article of manufacture as shown for use as an ornamental design for personalizing earphones/headphones as shown and described.

2. The device of claim wherein, the ornamental object is of any shape of extruded colored/decorative tubing.

3. The device of claim wherein, the ornamental object is made of any polymeric material, but not limited to so long as the colored/decorative tubing is still able to be applied and removed by a user to a pair of earphones/headphones as previously described.

4. The device of claim wherein, the ornamental object is of any length as to allow the user to completely ornament all wires of the earphones/headphones.
